(19) United States
(12) Patent Application Publication
(10) Pub. No.: US 2008/0196749 A1
(43) Pub. Date: Aug. 21, 2008

(54) Dishwasher and Manufacturing Method of the Same

(76) Inventor: Kyung Lae Kim, Gyeongsangnam-do (KR)

Correspondence Address: MCKENNA LONG & ALDRIDGE LLP, 1900 K STREET, NW, WASHINGTON, DC, 20006, US

(21) Appl. No.: 10/568,444

(22) PCT Filed: Aug. 24, 2005
(86) PCT No.: PCT/KR2005/002797

§ 371 Date: Feb. 15, 2006

(30) Foreign Application Priority Data
Sep. 1, 2004 (KR) 10-2004-0069441

(51) Int. Cl. A47L 15/42; B23P 11/00

(52) U.S. Cl. 134/57 D; 134/113; 29/428

(57) ABSTRACT

A dishwasher includes a control panel, a front panel disposed at the front of the control panel, a front display unit that slidingly couples to at least one of the control panel and the front panel and is disposed between the control panel and the front panel, and a sliding latch and a latch mounting slot that allow the front display unit to be slidingly coupled.

### TECHNICAL FIELD

The present invention relates to a dishwasher, and more particularly, to a dishwasher having a front display unit and a manufacturing method of the same.

### BACKGROUND ART

A dishwasher is a machine that uses electricity to automatically wash dishes. Depending on their dish-washing method, dishwashers can be divided roughly into two categories, spray dishwashers and ultrasonic dishwashers.

More specifically, spray dishwashers are used mostly for domestic applications, and use detergent dissolved in warm water that is sprayed to wash dishes stacked in racks. Devices for spraying water include a rotating spray arm that sprays water through multiple holes formed on the arm.

Ultrasonic dishwashers are used mainly for industrial applications, and apply ultrasound to water in which dishes are immersed in order to cause cavitation (low pressure regions created in the form of small bubbles) on the surfaces of the dishes to wash the dishes. These dishwashers use a highly alkaline detergent that does not easily produce bubbles (that weaken the force of a spray) and should also be non-toxic and harmless to humans, odorless, and colorless.

The operation of a related art household dishwasher is disclosed in Korean Patent Application No. 10-2002-0005710, filed by LG Electronics and entitled “Dish Washer and Operating Method for the Same”. A detailed description about a construction and operation of this patent application will be omitted.

A related art dishwasher has a front display unit attached to the front of the dishwasher that shows the status of a dishwashing cycle, the time remaining in the cycle, etc. The front display unit allows a user to easily view the operational status of the dishwasher and includes various display portions formed at its front.

The related art dishwasher has a control panel formed at the upper front portion of the dishwasher that includes a controlling portion and a display portion, with the display portion of the front display unit located on one side of the control panel and having a transparent window for displaying information that can readily be seen from the outside. Also, the front display unit is coupled to the rear of the control panel, and the display portion at the front is disposed at the rear of the display window.

By forming the components respectively in the locations described above, the information displayed on the display portion can be easily seen from the outside through the display window. In addition, the display window also functions as a protective covering for the front display unit to protect the latter from damage by shocks incurred from the outside.

In such a dishwasher, however, the front display unit is spaced considerably apart from the front panel when a separate front panel is attached to the front of the control panel for aesthetic reasons. Therefore, the information displayed in the display portion of the front display unit is difficult to perceive from the outside.

Additionally, the related art dishwasher has a structure where the control panel can be attached to the main body only after the front display unit is installed at the rear of the control panel. Resultantly, it is difficult to assemble the front display unit.

Furthermore, the related art dishwasher has a front display unit located at the rear of the control panel, making it difficult to disassemble the front display unit in case it requires repairs, etc.

### DISCLOSURE OF INVENTION

### Technical Problem

An object of the present invention is to provide a dishwasher having the attaching location of its front display unit altered so that data displayed on the front display unit can be easily seen from the outside, even if a front panel is added, and to provide a manufacturing method of the dishwasher.

Another object of the present invention is to provide a dishwasher having the attaching location of its front display unit altered so that assembly and disassembly thereof for servicing and other purposes can be performed easily, and to provide a manufacturing method of the dishwasher.

### Technical Solution

According to an aspect of the present invention, a dishwasher includes: a control panel; a front panel disposed at the front of the control panel; a front display unit slidingly coupled to at least one of the control panel and the front panel and disposed between the control panel and the front panel; and a sliding latch and a latch mounting slot for slidingly coupling the front display unit.

According to another aspect of the present invention, a dishwasher includes: a control panel; a front panel disposed at the front of the control panel; and a front display unit slidingly mounted to at least one of the control panel and the front panel to be disposed between the control panel and the front panel.

According to a further aspect of the present invention, a manufacturing method of a dishwasher includes: preparing a control panel, a front panel, and a front display unit; forming a sliding latch and a latch mounting slot for sliding the front display unit; and coupling the front display unit to at least one of the control panel and the front panel by sliding the sliding latch in the latch mounting receptacle.

### ADVANTAGEOUS EFFECTS

By locating the front display unit between the control panel and the front panel, the dishwasher and a manufacturing method of the same according to the present invention allows information displayed by the front display unit to be readily viewed from the outside, even if a front panel is added for aesthetic reasons.

The dishwasher and a manufacturing method of the same according to the present invention also allows easy assembly and disassembly of the front display unit by slidingly mounting it to the control panel. Consequently, the mounting of the front display panel becomes easier, as does its assembly and disassembly for manufacturing and servicing thereof.

### BRIEF DESCRIPTION OF THE DRAWINGS

The spirit of the present invention can be understood more fully with reference to the accompanying drawings. In the drawings:

FIG. 1 is a schematic sectional view showing the structure of a dishwasher in an upright position according to a first embodiment of present invention;

FIG. 2 is an exploded perspective view showing a front display unit and a control panel for the dishwasher according to the first embodiment of the present invention;

FIG. 3 is a perspective view showing the rear of the front display unit for the dishwasher according to the first embodiment of the present invention;

FIG. 4 is a perspective view showing a portion of the control panel to which the front display unit of the dishwasher according to the first embodiment of the present invention is attached;

FIG. 5 is a sectional view showing a portion of the control panel in an upright position to which the front display unit of the dishwasher according to the first embodiment of the present invention is attached;

FIG. 6 is a perspective view showing a sliding latch inserted into a latch mounting slot of a front display unit according to the present invention;

FIG. 7 is a perspective view showing the sliding latch of FIG. 6 inserted in and fixed to the latch mounting slot of the front display unit according to the present invention; and

FIG. 8 is an exploded perspective view of a front display unit and a front panel of a dishwasher according to a second embodiment of the present invention.

### BEST MODE FOR CARRYING OUT THE INVENTION

Hereinafter, preferred embodiments of a dishwasher according to the present invention will be described in detail with reference to the accompanying drawings.

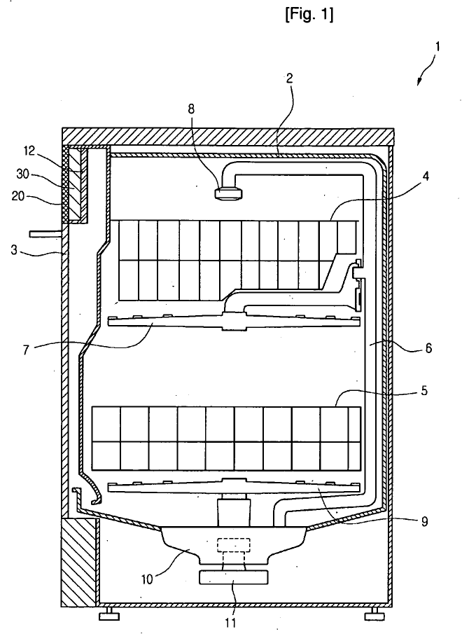

FIG. 1 is a schematic sectional view showing the structure of a dishwasher in an upright position according to a first embodiment of present invention.

Referring to FIG. 1, the dishwasher 1 includes a tub 2 forming the outer shape and an inner washing compartment of the dishwasher 1, a door 3 formed at the front of the tub 2 to open the washing compartment, and a sump 10 formed at the lower central portion of the tub 2 to holding wash liquid. A wash pump 11 for pumping wash liquid is disposed below the sump 10.

The dishwasher 1 also includes a water guide 6 for providing a passage for the wash liquid pumped by the wash pump 11, a lower spray arm 9 disposed above the sump 10 in the lower portion of the washing compartment for spraying wash liquid in an upward direction, an upper spray arm 7 connected to the upper portion of the water guide 6 to extend perpendicularly therefrom towards a central portion of the wash compartment, and top nozzle 8 formed at the ceiling of the tub 2 for spraying wash liquid in a downward direction.

In addition, an upper rack 4 for holding dishes to be washed by the upper spray arm 7 is installed above the upper spray arm 7 and a lower rack 5 for holding dishes to be washed by the lower spray arm 9 is installed above the lower spray arm 9.

In further detail, the upper rack 4 and/or the lower rack 5 are supported by rails (not shown) formed on the inner walls of the tub 2 to slide forward and backward.

The dishwasher 1 also has a control panel 12 disposed at the upper front portion thereof, the control panel 12 including various operating and/or controlling portions for the dishwasher 1. Also, a separate front panel 20 may be attached at the front of the control panel 12. The front panel 20 functions to protect the control panel 12 from. external shocks and form an aesthetically pleasing exterior surface of the dishwasher 1, and may therefore be formed of a predetermined metallic material.

Here, the display portion of the front display unit 30 on a surface of the front panel 20 may have a transparent window, so that the display portion can be seen from the outside.

A front display unit 30 (for displaying various information such as dishwasher 1 operation to be readily visible from the outside) is disposed between the control panel 12 and the front panel 20. Because the front display unit 30 is disposed between the control panel 12 and the front panel 20, the information displayed by the front display unit 30 can be readily viewed from the outside through the front panel 20.

The front display unit 30 may be slidingly attached to the control panel 12. In this case, the front display unit 30 may be coupled to the control panel 12 after the control panel is attached to the main body of the dishwasher 1, thus facilitating the coupling thereof. If it becomes necessary to remove the front display unit 30 due to an operational malfunction of the dishwasher 1, the front display unit 30 may be slidingly removed after the front panel 20 is disassembled, so that disassembly of the front display unit is easily performed.

Here, the front display unit 30 described as being attached to the front panel 12 is only exemplary. The front display unit 30 may be attached to the front panel 20 or attached to both the front panel 20 and the control panel 12.

The operation of the dishwasher 1 according to the present invention will now be described.

First, a user opens the door 3, and pulls out the upper and/or lower racks 4 and/or 5, whereupon dishes are placed therein. Next, the door 3 is closed, and power to the dishwasher 1 is turned on to begin its operation.

When power to the dishwasher 1 is turned on and a washing cycle begins, wash liquid flows into the sump 10. When the filling of the sump 10 is completed, the wash motor 11 begins to operate. An impeller inside a wash pump (not shown) that is connected axially to the wash motor 11 spins and pumps wash liquid to the lower spray arm 9 and the water guide 6.

The wash liquid pumped to the water guide 6 flows to the top nozzle 8 and the upper spray arm 7 from which it is sprayed into the wash compartment The sprayed wash liquid washes the dishes placed in the upper and/or lower rack(s) 4 and/or 5. Here, the top nozzle 8 sprays wash liquid in a downward direction, and the upper spray arm 7 sprays wash liquid in an upwardly perpendicular direction, so that dishes in the upper rack 4 are washed.

Furthermore, the lower spray arm 9 sprays wash liquid in an upwardly perpendicular direction to wash dishes placed in the lower rack 5. Spray openings may be formed on the bottom of the upper spray arm 7 to spray wash liquid in both upward and downward directions to simultaneously wash the upper portions of dishes placed in the lower rack 5.

When the wash cycle is completed, the dirty water collected in the sump 10 is drained out of the dishwasher 1 through a drain pump (not shown).

When the wash liquid is drained out of the dishwasher 1, fresh, clean wash liquid flows into the sump 10, and is sprayed through the spray arms 7 and 9. This clean wash liquid that is sprayed rinses the dishes in a rinse cycle.

When the rinse cycle is completed, a drying cycle is performed, completing the entire washing course.

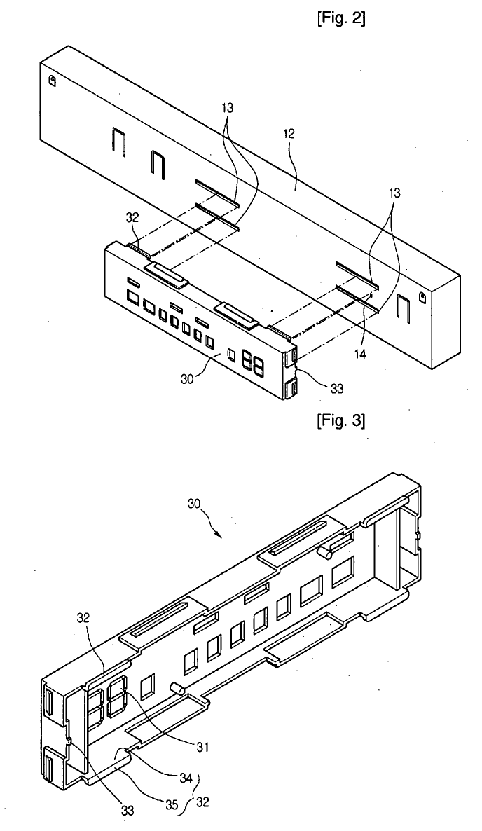

FIG. 2 is an exploded perspective view showing a front display unit and a control panel for the dishwasher according to the first embodiment of the present invention.

Referring to FIG. 2, a sliding latch 32 and a positioning tab 33 are formed at the rear of the front display unit 30. Formed at the front of the control panel 12 are a latch mounting slot 13 and a tab receptacle 14.

The sliding latch 32 slidingly couples to the latch mounting slot 13, and the positioning tab 33 inserts into the tab receptacle 14. Through this coupling method, which will be described later, the front display unit 30 is easily and reliably coupled to the control panel 12.

FIG. 3 is a perspective view showing the rear of the front display unit for the dishwasher according to the first embodiment of the present invention.

Referring to FIG. 3, the front display unit 30 has a display portion 31 formed on the front thereof that displays various information such as the operational status of the dishwasher 1.

At least one sliding latch 32 or more is formed on the rear of the front display unit 30. The sliding latch 32 has an extended portion 34 extending a predetermined distance from the front display unit 30 in a rearward direction and a bent portion 35 bent from the end of the extended portion 34. The sliding latch 32 couples to its counterpart on the control panel 12, so that the front display unit 30 can slidingly couple to the control panel 12.

Here, in order for an effective sliding coupling, the sliding latch 32 may come in at least one pair, with a pair consisting of one sliding latch 32 on the top of the front display unit 30 and another at a predetermined distance directly below the first sliding latch 32 on the bottom of the front display unit 30. For this purpose, the sliding latch 32 may be symmetrically opposed.

Furthermore, at least one positioning tab 33 is formed on a rear end of the front display unit 30. The positioning tab 33 forms a terminal coupling point that is an extension of a predetermined distance from the end of the front display unit 30. When the front display unit 30 is attached, the positioning tab 33 couples to its counterpart on the control panel 12 at the end of the sliding coupling movement of the front display unit 30, enabling the front display unit 30 to be fixed to the control panel 12.

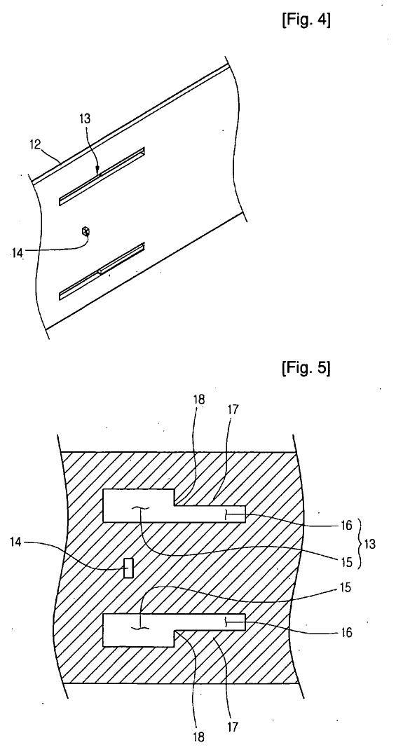

FIG. 4 is a perspective view showing a portion of the control panel to which the front display unit of the dishwasher according to the first embodiment of the present invention is attached, and FIG. 5 is a sectional view showing a portion of the control panel in an upright position to which the front display unit of the dishwasher according to the first embodiment of the present invention is attached.

Referring to FIGS. 4 and 5, a latch mounting slot 13 is defined by the control panel 12. When the front display unit 30 is mounted, the latch mounting slot 13 is a portion into which the sliding latch 32 inserts and slides. The number of latch mounting slots 13 formed may correlate to the number of sliding latches 32 formed.

In further detail, the latch mounting slot 13 includes an inserting slot 15 of a predetermined width and a securing slot 16 having another predetermined width that is less than that of the inserting slot 15. The securing slot 16 is defined by a securing slot forming portion 17. The sliding latch 32 is inserted in its entirety into the inserting slot 15. The extended portion 34 of the sliding latch 32 may insert into the securing slot 16, and the bent portion 35 thereof may contact the securing slot forming portion 17. In this case, the edge 18 of the securing slot forming portion 17 may be chamfered or rounded to better accommodate the inserting of the extended portion 34 of the sliding latch 32 into the securing slot 16.

The control panel 12 has at least one tab receptacle 14. After completion of the sliding movement of the front display unit 30, the tab receptacle 14 is coupled with the positioning tab 33, to fix the front display unit 30 to the front of the control panel 12.

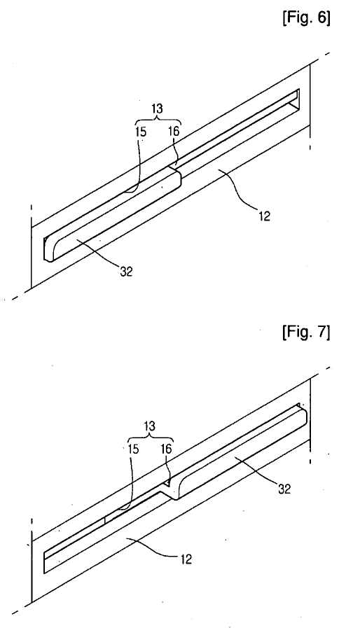

FIGS. 6 and 7 show the process of coupling a front display unit to a control panel of a dishwasher according to the first embodiment of the present invention.

FIG. 6 is a perspective view showing a sliding latch inserted into a latch mounting slot of a front display unit according to the present invention, and FIG. 7 is a perspective view showing the sliding latch of FIG. 6 inserted in and fixed to the latch mounting slot of the front display unit according to the present invention.

First, as shown in FIG. 6, the sliding latch 32 is inserted into the latch mounting slot 13. Specifically, the sliding latch 32 is inserted in the latch mounting slot 13 through the inserting portion 15 thereof. Here, the extended portion 34 and the bent portion 35 of the sliding latch 32 are both inserted into the inserting portion 15. The at least one pair of sliding latches 32 formed on the front display unit 30 slide respectively and simultaneously into the at least one pair of latch mounting slots 13 formed on the control panel 12.

Next, the sliding latch 32 is slid towards the securing slot 16 by means of an external force. Resultantly, the extended portion 34 fits into the securing slot 16, and the bent portion 35 contacts the securing slot forming portion 17, as shown in FIG. 7. Here, edges 18 of the securing slot forming portion 17 are chamfered or rounded to all of the extended portion 34 to fit easily into the securing slot 16.

When the above sliding motion is completed, the sliding latch 32 is fixed to the fastening portion 16. Accordingly, the front display unit 30 is securely fixed to the control panel 12. Here, the positioning tab 33 inserts into the tab receptacle 14 to stop the sliding motion of the front display unit 30 and fix the position of the front display unit 30.

When the at least one pair of sliding latches 32 formed on the front display unit 30 slide respectively into the at least one pair of corresponding latch mounting slots 13, the front display unit 30 is supported in its entirety. The front display unit 30 can thus be attached more securely to the control panel 12.

In the above-structured dishwasher and manufacturing method thereof, the front display unit is disposed between the control panel and the front panel, and even if a front panel is added for aesthetic reasons, information displayed by the front display unit can still easily be seen from the outside.

Furthermore, in the above dishwasher and manufacturing method thereof, the front display unit slidingly couples to the control panel, so that it can easily be detached. Accordingly, the mounting of the front display unit is facilitated, and attaching and detaching thereof for manufacturing and servicing becomes easier.

### MODE FOR THE INVENTION

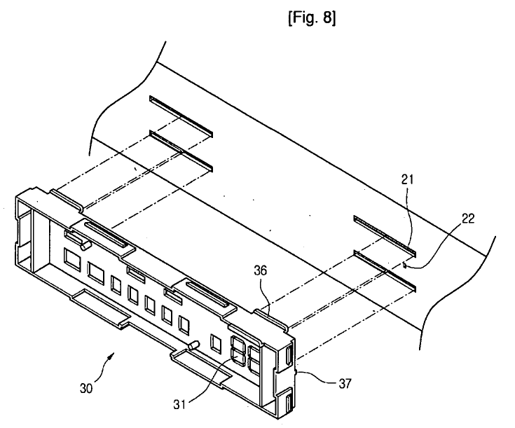

FIG. 8 is an exploded perspective view of a front display unit and a front panel of a dishwasher according to a second embodiment of the present invention.

Referring to FIG. 8, a sliding latch 36 and a positioning tab 37 are formed on the front of the front display unit 30 according to the second embodiment of the present invention. A latch mounting slot 21 for coupling with the sliding latch 36 and a tab receptacle 22 for coupling with the positioning tab 37 are formed at the rear of the front panel 20.

The coupling of the sliding latch 36 to the latch mounting slot 21 and the positioning tab 37 with the tab receptacle 22 are the same as in the first embodiment

In the above structure, the front display unit 30 can be easily and securely mounted to the front panel 20.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The dishwasher and manufacturing method thereof according to the present invention allows data displayed by the front display unit to be readily viewed from the outside, and enables the front display unit to be easily mounted and detached, to provide a high industrial applicability.

1. A dishwasher comprising:
a control panel;
a front panel disposed at a front of the control panel;
a front display unit slidingly coupled to at least one of the control panel and the front panel and disposed between the control panel and the front panel; and
a sliding latch and a latch mounting slot for slidingly coupling the front display unit.

2. The dishwasher according to claim 1, wherein the sliding latch and the latch mounting slot are formed in at least one pair or more.

3. The dishwasher according to claim 2, wherein the sliding latch and the latch mounting slot are respectively formed opposite to one another.

4. The dishwasher according to claim 1, wherein the sliding latch is formed on the front display unit.

5. The dishwasher according to claim 4, wherein the sliding latch is formed on at least one of the control panel and the front panel.

6. The dishwasher according to claim 1, wherein the sliding latch includes an extended portion extending a predetermined distance and a bent portion bending from the extended portion.

7. The dishwasher according to claim 1, wherein the latch mounting slot includes an inserting slot having a predetermined width and a securing slot having another predetermined width less than the width of the inserting slot

8. The dishwasher according to claim 7, wherein an edge of a securing slot forming portion forming the securing slot is chamfered or rounded.

9. The dishwasher according to claim 1, further comprising a positioning tab and a tab receptacle for positioning the front display unit after the front display unit has completed sliding.

10. The dishwasher according to claim 9, wherein the positioning tab is formed on the front display unit, and the tab receptacle is formed on at least one of the control panel and the front panel.

11. The dishwasher according to claim 9, wherein the positioning tab and the tab receptacle are positioned to couple when the front display unit has completed sliding.

12. The dishwasher according to claim 1, wherein the front panel includes a display window formed thereon for allowing information displayed by the front display unit to be viewed from the outside.

13. A dishwasher comprising:
a control panel;
a front panel disposed at a front of the control panel; and
a front display unit slidingly mounted to at least one of the control panel and the front panel to be disposed between the control panel and the front panel.

14. The dishwasher according to claim 13, further comprising a sliding latch and a latch mounting slot for sliding the front display unit.

15. The dishwasher according to claim 13, further comprising a positioning tab and a tab receptacle for positioning the front display unit after the front display unit has completed sliding.

16. A manufacturing method of a dishwasher, comprising:
preparing a control panel, a front panel, and a front display unit;
forming a sliding latch and a latch mounting slot for sliding the front display unit; and
coupling the front display unit to at least one of the control panel and the front panel by sliding the sliding latch in the latch mounting receptacle.

17. The manufacturing method according to claim 16, wherein the forming of the sliding latch includes forming an extended portion and a bent portion bent from the extended portion, and the forming of the latch mounting slot includes forming an inserting slot having a predetermined width and a securing slot having another predetermined width less than the width of the inserting slot.

18. The manufacturing method according to claim 17, wherein the coupling of the front display unit includes:
inserting the sliding latch in the latch mounting slot; and
sliding the sliding latch for securing the sliding latch in the securing slot

19. The manufacturing method according to claim 16, wherein the preparing of the control panel, the front panel, and the front display unit includes forming a positioning tab and a tab receptacle.

20. The manufacturing method according to claim 19, wherein the coupling of the front display unit includes positioning the front display unit by coupling the positioning tab to the tab receptacle.
